(19) United States
(12) Patent Application Publication
(10) Pub. No.: US 2016/0131022 A1
(43) Pub. Date: May 12, 2016

(54) CONTROL CAPSULE FOR AN EXHAUST-GAS TURBOCHARGER

(71) Applicant: BORGWARNER INC., Auburn Hills, MI (US)

(72) Inventors: Nicolas REGENT, Steinbach (DE); Raduz ZAHORANSKY, Marnheim (DE)

(21) Appl. No.: 14/896,461

(22) PCT Filed: Jun. 19, 2014
(86) PCT No.: PCT/US2014/043212

§ 371 Date: Dec. 7, 2015

(30) Foreign Application Priority Data
Jun. 21, 2013 (DE) 102013010409.2

(51) Int. Cl. F02B 37/18

(52) U.S. Cl. CPC F02B 37/186

(57) ABSTRACT

A control capsule for a regulating device of an exhaust-gas turbocharger;
having a housing in which there are formed a first air chamber and a second air chamber which are separated from one another in gas-tight fashion by a spring-loaded diaphragm;
having a regulating rod which is connected in force-transmitting fashion to the diaphragm, A
hole connects the second air chamber in gas-conducting fashion to the surroundings of the housing. The hole has a hole area of greater than 20 mm².

The invention relates to a control capsule for a regulating device of an exhaust-gas turbocharger, as per the preamble of claim 1.

A control capsule of this type is known from EP 1 491 754 A1. The control capsule is suitable for being used for opening and closing a bypass valve of a turbocharger. In the case of said control capsule, the closing movement takes place with a greater exertion of force, specifically in the direction of action of a compression spring, than the opening movement, which takes place counter to the spring force. The control capsule has two air chambers which are separated by a diaphragm, and both the air chambers can be set either to atmospheric pressure or to negative pressure.

The static stiffness of a control capsule of said type is defined by the installed spring, which preloads the diaphragm, and also by the diaphragm that is used. The dynamic stiffness of a control capsule is dependent on the speed of a change of stroke. At low speed, the air in an air chamber that is not charged with pressure or negative pressure can escape through openings that are provided. During very fast changes of stroke, however, the air chambers behave as if they were sealed, and every diaphragm movement leads to a pressure change in the air chambers. The result is a very much higher dynamic stiffness of the control capsule.

Such fast changes of stroke that are introduced into the control capsule via the regulating rod by the exhaust-gas pulsations increase the dynamic stiffness in the stated manner, whereby increased wear may occur in particular in the range of a natural frequency of the control capsule.

It is therefore the object of the present invention to provide a control capsule of the type specified in the preamble of claim 1, by means of which control capsule it is possible for the effects of vibrations introduced into the control capsule by exhaust-gas pulsations, in particular the resulting wear, to be at least reduced.

This object is achieved by the features of claim 1. The invention accordingly provides a control capsule for a regulating device of an exhaust-gas turbocharger, having a housing in which there are formed a first air chamber and a second air chamber which are separated from one another in gas-tight fashion by a spring-loaded diaphragm; having a regulating rod which is connected in force-transmitting fashion to the diaphragm, comprising a hole which connects the second air chamber in gas-conducting fashion to the surroundings of the housing, wherein the hole has a hole area of greater than 20 mm².

The dependent claims relate in each case to further advantageous refinements which may be combined with one another in a technologically expedient manner, wherein, in some cases, effects may also be obtained which go beyond the sum of the individual effects. The description, in particular in conjunction with the drawing, characterizes the invention further.

Owing to the relatively large hole area that connects the second air chamber in gas-conducting fashion to the surroundings, it is possible for the control capsule to be rapidly ventilated, such that neither a positive pressure nor a negative pressure can form in the second air chamber. The air volume situated in the second air chamber thus does not form an additional spring in the event of fast changes of stroke.

In one refinement, the control capsule has a restrictor plate that interacts with said hole.

The restrictor plate influences the throughflow capacity of the hole. By influencing the throughflow capacity of the hole, it is possible for the dynamic stiffness to be influenced in a targeted manner, which means that the natural frequency of the control capsule is shifted into a frequency range which does not arise, or arises only seldomly, during operation.

In a further refinement, the control capsule has a valve that interacts with the hole.

The valve may be closed in order to vary the natural frequency of the control capsule during operation.

In a further refinement, the control capsule has a sheet-metal element which, in the second air chamber, forms a third air chamber which is connected to the second air chamber via a further hole.

The second air chamber is in turn divided into two chambers in this way. The chamber that is situated closest to the diaphragm is thus protected against contamination. The further hole serves for connecting the two air chambers to one another, wherein references made herein to the configuration and size of the hole likewise apply to the further hole.

In one refinement, the further hole serves as a leadthrough opening for a regulating rod.

This may likewise apply to a control capsule without a sheet-metal element and divided second air chamber. Accordingly, elements that are already provided can be used to form a hole by being redesigned, specifically by virtue of the passage opening of a conventional control capsule being correspondingly widened.

In the case of relatively small control capsules with control capsule diameters of greater than 20 mm and less than 65 mm, the hole may have a hole area of greater than 23 mm², particularly preferably greater than 26 mm².

In the case of relatively large control capsules, for example for high powered turbochargers or for flap-type control arrangements in supercharging systems with multiple switchable superchargers and control capsule diameters of greater than 65 mm and less than 180 mm, the hole may have a hole area of greater than 28 mm², in particular greater than 38 mm², particularly preferably greater than 50 mm².

Further details, advantages and features of the present invention emerge from the following description of exemplary embodiments with reference to the drawing, in which:

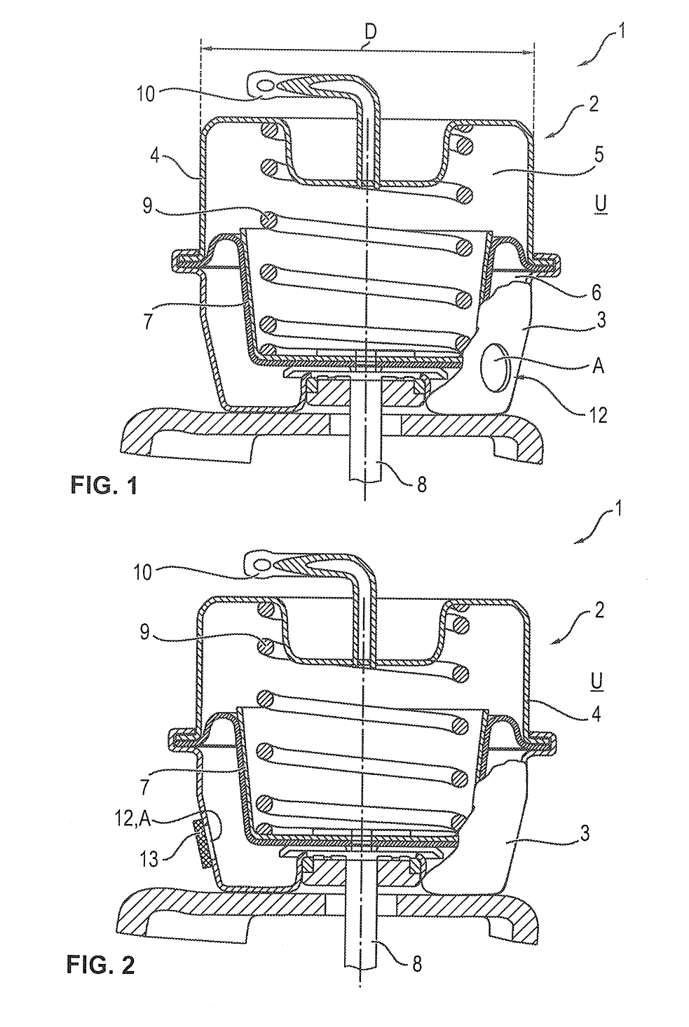

FIG. 1 shows, in a partially sectional view, a schematically slightly simplified embodiment of a control capsule with a hole,

FIG. 2 schematically shows a control capsule with a hole and with a restrictor flap situated over said hole,

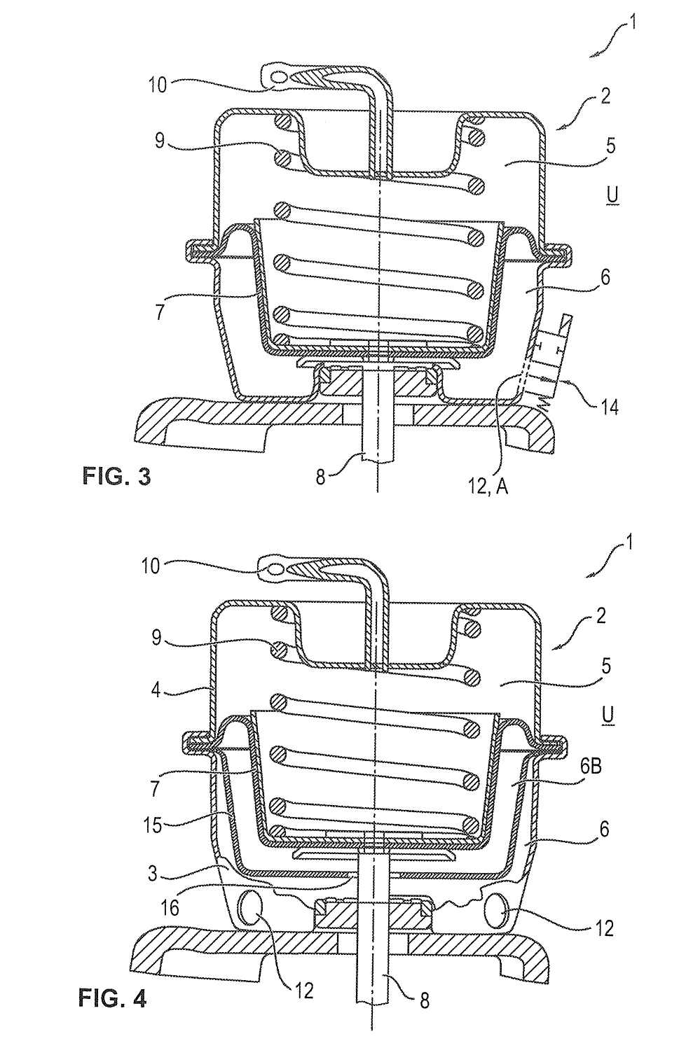

FIG. 3 shows an embodiment of a control capsule with a hole and with a valve, and

FIG. 4 shows a control capsule with an air chamber which is divided by a sheet-metal element into two air chambers, wherein the air chambers are connected to one another in gas-conducting fashion.

FIG. 1 illustrates a first embodiment of a control capsule 1 according to the invention. The control capsule 1 has a housing 2 which comprises a housing base part 3 and a housing cover 4 connected to the housing base part 3. In the housing 2 there is arranged a diaphragm 7 which, at the edge, is fixed between the housing base part 3 and the housing cover 4, and as a result of the arrangement of which a first air chamber 5 and a second air chamber 6 are formed, these being separated from one another in gas-tight fashion by the diaphragm 7. The control capsule 1 is designed for actuating a regulating device (not illustrated) of an exhaust-gas turbocharger (likewise not illustrated). The exhaust-gas turbocharger serves in turn for the supercharging of an internal combustion engine (not illustrated). The internal combustion engine may be operated at varying engine speeds, wherein said internal combustion engine outputs an exhaust-gas stream with an engine-speed-dependent pressure pulsation. The pressure pulsation is also transmitted via the diaphragm 7 to the air situated in the air chambers 5 and 6. The exhaust-gas stream may be used for operating a turbine provided in the exhaust-gas turbocharger.

FIG. 1 also shows that the diaphragm 7 is preloaded by a spring 9 and is connected to a regulating rod 8 which extends out of the housing 2. In an installed state which is not illustrated, a line is connected to a connector 10 in order to enable the control capsule 1 to be controlled by way of an external pressure which is lower than an ambient pressure (referred to colloquially as “negative pressure”). The control capsules 1 shown in FIGS. 1 to 4 are negative-pressure-controlled control capsules 1, though the core concept of the invention, of the variation of the dynamic stiffness, can readily be applied to pressure-controlled control capsules (not illustrated).

The first embodiment of the control capsule 1 illustrated in FIG. 1 has, in the housing base part 3, a hole 12 for the fluid-conducting or gas-conducting connection of the second air chamber 6 to the surroundings U of the control capsule 1. In other words, the hole 12 serves for the ventilation of the control capsule 1. Here, the hole 12 is relatively large, such that it constitutes only a relatively small throttling resistance for an air flow. During a change of stroke of the control capsule 1, air is displaced out of or drawn into the second air chamber 6 depending on the direction of the change of stroke. By virtue of the fact that the hole 12 is relatively large, it is not possible for a significant pressure or a negative pressure to build up in the second air chamber 6. The so-called dynamic stiffness of the control capsule 1 can thus be kept low.

The control capsule 1 may have relatively small control capsule diameters D of greater than 20 mm and less than 65 mm. The hole area A that is formed by the hole and remains free in the case of these relatively small control capsules is in this case greater than 20 mm², in particular greater than 23 mm², particularly preferably greater than 26 mm².

In the case of relatively large diameters D of greater than 65 mm and less than 180 mm, the hole area A that is formed by the hole 12 and remains free may be greater than 28 mm², in particular greater than 38 mm², particular preferably greater than 50 mm².

The hole 12 may be circular, though may also have other cross sections. The “hole” does not need to be a single opening, and may also, in a manner not illustrated, be formed from multiple openings which collectively have the stated hole area A, corresponding to FIG. 4.

The embodiment in FIG. 2 corresponds, with regard to all corresponding reference signs, to that of FIG. 1, such that reference may be made to the description above.

The embodiment of the control capsule 1 in FIG. 2 also has a hole 12 with a hole area A in the housing base part 3 and an associated restrictor plate 13. FIG. 2 shows the restrictor plate 13 in a position in which it at least partially closes off the hole 12. The restrictor plate 13 is however provided such that, in a manner dependent on the occurrence of high-frequency vibrations, it correspondingly opens the hole 12 in order to be able to influence the dynamic control capsule stiffness in accordance with the degree of opening of the hole 12.

The embodiment in FIG. 3 again corresponds, with regard to all corresponding reference signs, to the embodiments in FIGS. 1 and 2, such that, with regard also to FIG. 3, reference may be made to the statements given above.

The embodiment in FIG. 3 has a hole 12 in the housing base part 3 and an associated valve 14 which, depending on the operating conditions of the internal combustion engine, can open the hole 12 to a greater or lesser extent. Said valve may be a proportional valve or a switching valve. The control capsule 1 has a different natural frequency when the valve 14 is open, so as to enable flow to pass through the hole 12, than when the valve 14 is closed or partially closed. The valve 14 can accordingly be controlled in a frequency-dependent or engine-speed-dependent manner such that the corresponding natural frequency is not passed through.

FIG. 4 shows a fourth embodiment of a control capsule 1 according to the invention, in which, again, all elements that correspond to the embodiments in FIGS. 1 to 3 are identified by the same reference numerals.

The embodiment of the control capsule 1 in FIG. 4 has a sheet-metal element 15 which, in the second air chamber 6, forms a further air chamber 6B. The second air chamber 6 and the further air chamber 6B are connected to one another in fluid-conducting fashion via a further hole 16. The hole 16 serves simultaneously for the leadthrough of the regulating rod 8.

It would in principle also be possible for a multiplicity of air chambers to be provided in the housing base part 3, for which purpose it would then be necessary to provide a corresponding number of further sheet-metal elements which are connected to one another in terms of flow in each case via different restrictors in order to permit a targeted setting, which can be adapted to the respective application, of the dynamic control capsule stiffness.

In addition to the above written disclosure of the invention, reference is hereby explicitly made, for supplementation thereof, to the illustrative presentation of the invention in FIGS. 1 to 4.

### LIST OF REFERENCE SIGNS

1 Control capsule
2 Housing
3 Housing base part
4 Housing cover
5 First air chamber
6 Second air chamber
7 Diaphragm
8 Regulating rod
9 Spring
10 Connector
11 Restrictor
12 Hole
13 Restrictor plate
14 Valve
15 Sheet-metal element
6B Third air chamber
16 Hole
A Hole area
D Control capsule diameter

1. A control capsule (1) for a regulating device of an exhaust-gas turbocharger; having
a housing (2) in which there are formed a first air chamber (5) and a second air chamber (6) which are separated from one another in gas-tight fashion by a spring-loaded diaphragm (7);
a regulating rod (8) which is connected in force-transmitting fashion to the diaphragm (7), and
a hole (12) which connects the second air chamber (6) in gas-conducting fashion to the surroundings (U) of the housing (1), wherein the hole (12) has a hole area (A) of greater than 20 mm².

2. The control capsule as claimed in claim 1, having (1) a restrictor plate (13) that interacts with said hole (12).

3. The control capsule as claimed in claim 1, having a valve (14) that interacts with said hole (12).

4. The control capsule as claimed in claim 1, having a sheet-metal element (15) which, in the second air chamber (6), forms a third air chamber (6B) which is connected to the second air chamber (6) via a further hole (16).

5. The control capsule as claimed in claim 4, wherein the further hole (16) serves as a leadthrough opening for a regulating rod (8).

6. The control capsule as claimed in claim 1, having a control capsule diameter (D) of greater than 20 mm and less than 65 mm and having a hole area (A) of greater than 23 mm², particularly preferably greater than 26 mm².

7. The control capsule as claimed in claim 1, having a control capsule diameter (D) of greater than 65 mm and less than 180 mm and having a hole area (A) of greater than 28 mm², in particular greater than 38 mm², particularly preferably greater than 50 mm².
